(19) United States
(12) Patent Application Publication
(10) Pub. No.: US 2004/0227299 A1
(43) Pub. Date: Nov. 18, 2004

(54) Magnetic bearing isolator

(76) Inventor: Brian Simmons, Orange Park, FL (US)

Correspondence Address: VEDDER PRICE KAUFMAN & KAMMHOLZ, 222 N. LASALLE STREET, CHICAGO, IL, 60601, US

(21) Appl. No.: 10/838,573

(22) Filed: May 4, 2004

Related U.S. Application Data
(60) Provisional application No. 60/469,149, filed on May 12, 2003.

(51) Int. Cl. F16J 15/32; F16J 15/43

(52) U.S. Cl. 277/410

(57) ABSTRACT

A magnetic bearing isolator assembly. The assembly comprises first and second body parts, a ferromagnetic ring and a plurality of magnets received in spaced apart pockets. The first body part has a circumferential groove for receiving a ring of a ferromagnetic material. A radially outer groove in the first body part accommodates the second body part which has an outer, frusto-conical surface which is very slightly larger than the diameter of the smaller axial surface on the first part. The first and second parts are made from a composite fluorocarbon-carbon-graphite material with substantial glass filling therein.

This application claims priority under 35 U.S.C. §119(e) to U.S. Provisional Application Ser. No. 60/469,149, filed May 12, 2003, which is expressly incorporated by reference herein.

### BACKGROUND OF THE INVENTION

The present invention relates generally to oil seals, and more particularly to a composite seal wherein the sealing faces are urged together by magnetic force.

The present invention is particularly useful in areas where other seals have not proven to be particularly successful. For example, one of the characteristics of the present seal is that, in addition to sealing oils or other lubricants, it is capable of providing an airtight seal.

This is in contrast to some other prior art seals intended to seal a lubricant, such as the labyrinth type seal. Whereas a labyrinth type seal is moderately to very effective in sealing liquids, such as a liquid lubricant, such seals are not at all proof against any air pressure. Such seals have no air exclusion capability, and consequently, during a heating cycle, such seals will expel air containing moisture, and thereafter, when cooling, will draw in and condense air containing such moisture inside the sealed space and leave it to corrode the bearings or other sealed parts.

Mechanical end face seals have overcome the problem of moisture condensation, but in such seals, the end faces are urged together either by one or more O-rings which slide up and down a conical ramp, or by elastomeric members in the shape of a parallelogram. Such seals are very effective, but they are generally suitable only for slower speeds, and thus lack the capacity to be used in applications where lubrication is at a minimum or non-existent and higher speed devices such as electric motors or the like have commonly not been used.

A further variation of such end face seals has been the type of seal wherein the sealing force derives from a coil, spring, or less commonly, a bellville washer type spring. Such springs are also not particularly effective in dry running situations and especially wherein relatively high rpms are needed. In all such seals, moreover, the seals have presently not performed to their best advantage in the presence of corrosive liquids, or other atmospheres in which the sealed liquids attack the mechanical portion of the seal.

The present invention, however, is particularly advantageous in sealing applications wherein the atmosphere or sealed liquid is corrosive or which otherwise attacks the seals. The present invention is also particularly useful wherein a constant sealing force is generally required and wherein there is relatively little end play in the surfaces ought to be sealed.

Accordingly, it is an object of the present invention to provide an improved magnetic end face seal or isolator.

Another object of the present invention is to provide a seal having two major components which are made from identical, inherently lubricous, corrosion-resistant materials.

A still further object of the invention is to provide a seal having a plurality of cylindrical magnets entrapped within one component of the seal and precisely spaced from the other component.

Another object is to provide a seal wherein the cylindrical magnets which provide the sealing force are entrapped in their positions by means of a slight lip or overlap of the material covering the magnets.

A further object of the invention is to provide a magnetic seal wherein the magnets are situated in one component and the other component contains an entrapped ring of a ferromagnetic material secured in a groove and held a fixed distance from the magnets providing the attractive force.

Another object is to provide a seal wherein the two components are made of a composite fluorocarbon-carbon graphite, and glass material.

Another object of the invention is to provide a mechanical arrangement whereby the parts or components of the seal, once assembled, cannot separate, but are held together permanently.

A still further object of the invention is to provide a seal wherein a pair of grooves are provided for two O-rings or other seals which comprise the secondary or non-rotatable seal and in which one other groove is an enlarged groove which serves to retain the two pieces together.

Another object is to provide a seal with a small groove which retains the ferromagnetic portion in position in the stationary component of the seal.

Another object is to provide a seal containing magnets made from neodymium 40 iron boron and/or other rare earth materials.

Another object is to provide a seal with corrosion-resistant materials, including nickel plated magnets and a ferromagnetic ring.

These objects and others are achieved by providing a seal with two major components which are dimensioned so as not to come apart, and the seal includes a ferromagnetic ring retained in a groove, a plurality of magnets positioned in pockets and a primary end face seal formed by surfaces on the two opposed components.

The manner in which these and other objects and advantages of the present invention are achieved in practice will become more clearly apparent when references made to the following detailed description of the preferred embodiments of the invention, and shown in the accompanying drawings, wherein like reference numbers indicate corresponding parts throughout.

### BRIEF DESCRIPTION OF THE DRAWINGS

FIG. 1 is a vertical sectional view of the two parts making up the composite seal of the invention, and a fragmentary view of the housing and the shaft sealed thereby;

FIG. 2 is view of the same seal of the invention, showing the two components before their assembly into a single unitized seal assembly.

FIG. 3 is an exploded view of the isolator showing the manner of placing the ferromagnetic ring in the isolator.

### DESCRIPTION OF THE PREFERRED EMBODIMENTS OF THE INVENTION

While the invention may be embodied in various forms, a description will be given of a preferred embodiment of the invention wherein it is used to seal a shaft for a fluid pump or the like.

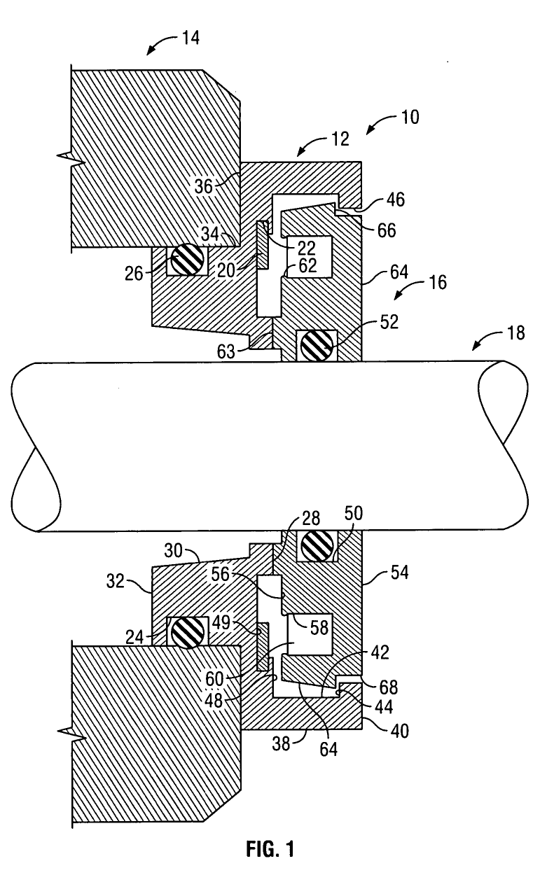

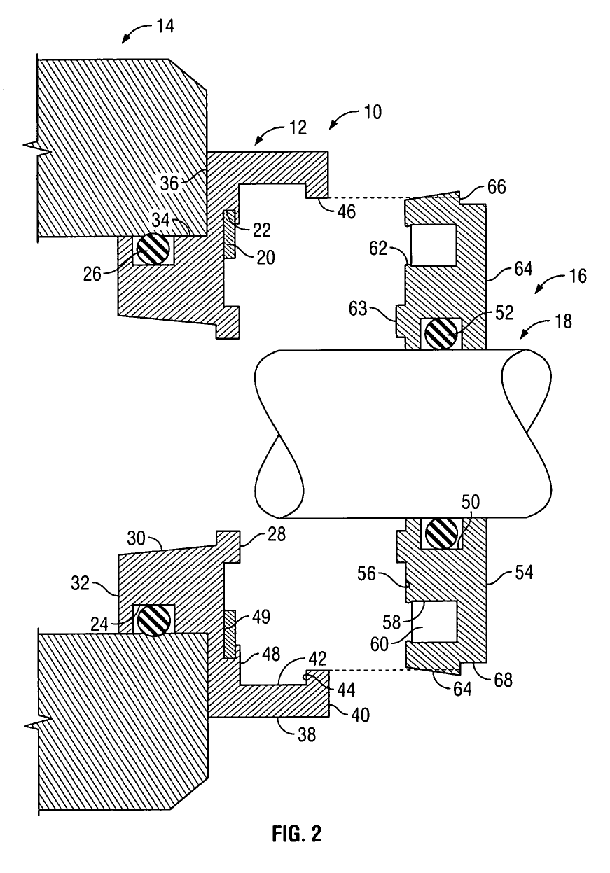

Referring now to the drawings in greater detail, a combination bearing isolator or fluid seal generally designated 10 is shown in FIGS. 1 and 2 to be comprised of a stationary part generally designated 12, which is received within a housing generally designated 14, and a movable or rotary part generally designated 16 which is received over a rotatable shaft generally designated 18. The shaft 18 is connected to a pump or the like, while the housing contains the lubricant.

A third part or component is the ferromagnetic ring 20 (in this case made from steel), which is held in place against any axial movement by being received within a circumferential groove 22 within the first or stationary part 12. The first part 12 also preferably includes a circumferential groove 24 for receipt of a O-ring 26 which provides a secondary seal between the first component and the housing 14 or the like.

In addition, the first part 12 contains a number of elements, including an annular end face surface 28 which will meet and form the primary seal with a counterpart surface on the second component. In addition, there is a slightly outwardly tapering surface 30 which terminates in a radially extending surface 32, the purpose of which will appear presently.

The first part is retained in place within the housing 14 by an axially extending cylindrical surface 34, which keeps the radially extending surface 36 in place against the housing 14. The outer diameter of the first part or component is defined by a cylindrical surface 38, while a radial annular surface 40 defines the axially outward extent of the body 12. In addition, there is defined within the body 12, an enlarged circumferential groove 42, which is defined in part by radial surface 44, which terminates at its inner diameter on axial surface 46. The surface 44 provides an engagement surface to prevent the second component from separating from the first component, as will be described. There is another annular inner end face surface 48 which lies just outside the circumferential groove 22 serving to retain the ring 20 in place within the first component. The groove 22 is also partially defined by the radial body surface 49.

Referring now to the second major part or component of the invention, this unit, generally designated 16, is comprised of a groove 50 for receiving an O-ring 52, an axially outer end face 54 and an axially inner end face 56. In addition, there are periodically circumferentially spaced apart pockets 58 adapted to receive cylindrical magnets 60. The second part 16 includes slightly rolled over edges 62 to prevent the magnets from escaping their entrapment in the pockets of the second part 16. In addition, there is a tapered outer, frusto-conical surface 64, a small radial end face surface 66 and a smaller cylindrical surface 68, which surfaces serve to prevent the end faces 44, 46 on the first part 12 from separating.

The fact that there is a very slight radical overlap between the circumferential surface 66 and the radial surface 44 of the first component 12, enables the second component 16 to be positioned within the first component, but only after the two are pressed together. The frusto-conical surface 64 initially engages the cylindrical surface 46, and the driving force exerted by a hydraulic arbor press to assemble these components enables the second component to “pop in” and be received within the first component, the two thereafter not being separable.

As shown, the other end face sealing surface 63 is the surface which engages its counterpart 28 when the parts are locked together. The end face surfaces 63, 28 are opposed to each other and provide a fluid-tight seal when the magnet 60 is drawn into proximity with the ferromagnetic (in this case steel) ring by magnetic attraction. The so-called reluctance gap is preferably 55 thousandths of an inch (0.055″) to 75 thousandths of an inch (0.075″) for shafts up to six inches in diameter, and thereafter, with larger magnets, the gap is preferably 0.075″.

Referring now to the method of making the seal, the two parts or components of the seal are preferably made from a material comprised of about 60% fluorocarbon material, 20% of a carbon graphite material and 20% of a glass filler. The advantage of this material used in the construction of these parts is that the material provides strength, stability and an extremely low coefficient of friction. Consequently, the two faces 63, 28 can rub together without generating measurable frictional heat. The further advantage is that this material allows a seal to be used in environments which can be found in chemical plants, pulp and paper manufacturing, or mining operations, for example, which are well known for their use of aggressive, corrosive products in their various operations.

The composite seal requires a ferromagnetic member 20, such as iron or steel to be used and entrapped in the groove 22 of the type shown. The other or second component 16 of the seal uses a plurality, preferably six or eight, equally spaced pockets to accommodate the magnets. The magnets themselves are preferably in the form of small cylinders, for example 0.189 inches in diameter by 0.0200 inches long. These magnets are all positioned in a die so that the same pole points in the same direction. Thus, there are no eddy currents produced which would create significant heat if the magnets were alternately positioned with their north and south poles alternately facing the same direction.

The magnets used in this embodiment of the invention are preferably rare earth magnets, particularly using neodymium 40 iron boron. These magnets are formed into a cylindrical shape and then nickel plated to protect them from corrosion.

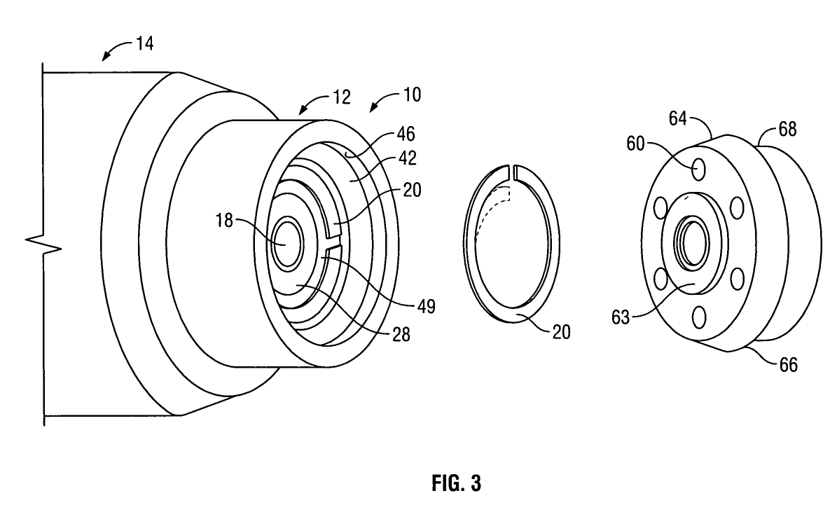

The steel ring (20) is shown to be of a flexible type which can be compressed, forced into a somewhat smaller diameter as shown in FIG. 3, and then allowed to expand into its installed position as best shown in FIGS. 1 and 2 within the groove 22. Preferably, the steel ring will be nickel coated for corrosion resistance if exposed to corrosive vapors. The steel ring 20 may be made from tempered steel having a slight oil coating thereon.

The second part or component 16 is also molded using the composite material just described, wherein it is exposed to heat in the vicinity of 600 to 700 degrees Fahrenheit, wherein it becomes moldable and completely surrounds the magnets as shown, with lips 62 or like entrapping means holding the magnets in their positions. Thus, although strongly attracted to the steel ring 20, the magnets will not be pulled out of their pockets.

Referring now to forming the two non-magnetic parts 12, 16 of the seal or isolator, a mold having each of the exact shapes desired is formed in two parts. Each mold is then filled with the desired 60-20-20 mix of material in powder form. Next, each mold is closed with a force of 200 tons or more, resulting in “green” parts. These parts are then placed in an oven and heated at 600°-700° until the parts are sintered throughout.

Thereafter, each sintered part 12, 16 is removed from the oven, and with a CNC (computer numerical controlled) machine, is formed to its final shape, including the shape of the seal faces 28, 63. During this time, the pockets 58 are formed, preferably with a diameter that is 0.003 inches smaller than the diameter (0.189″ or 0.250″) of the magnetic cylinders. This provides the necessary interference, especially in view of the cold-flow propensities of the composite material. The magnets are then pressed into the pockets 58 to a depth of 0.015 to 0.030 inches less than the pocket depth. In other words, the pocket 58 surrounding the opening extends beyond the length of the magnet 60 by 0.015″ to 0.030″. Thus, there is a lip 62 slightly overlying the magnet 58.

When the parts 12, 16 or components are formed, the seal may then be assembled by first compressing the steel ring 20 to a slightly smaller diameter, as shown in dotted lines in FIG. 3, placing it axially within the groove, and then releasing the confining pressure, allowing it to expand and slip into the groove 22, where it is held against axial displacement by means of the radial flange or lip 48. Thereafter, the parts 12, 16 may be aligned and forced together such that the tapered surface 64 fits within the cylindrical surface 46 under the influence of a strong manually operated hydraulic arbor press.

Once the tapered surface 64 passes the axial flange 46, the seal unit pops into place and the magnetic attraction as the two faces 63,28 engage each other. If there is a slight misalignment, there is no permanent difficulty because the faces lap in during the first five to eight seconds of rotation. This feature is important, especially if placed on shafts that are subject to deflection or have large overhung loads such as in certain pumps and in pillow block bearings. The unitized seal or cartridge seal thus may be installed in a pump or the like by pressing it into the housing and over the shaft. The first part 12 of the seal combination includes a tapered wall 30 and a radially extending wall 32. This form of seal has proved effective in the event that the oil level on the bearings sealed by this product are at an undesired or incorrect level. This allows the oil to drain from the faces 28,63 on the surfaces 30,32.

Since the seal is a cartridge or a unitized seal, if the shaft moves axially, the interference between parts at the outer diameter of the second part will ensure that the seal is not subject to separation by this method. The magnets have been described for example as being 0.189 inches by 0.20 inches in diameter. A larger size, 0.250 inches in diameter with a length of 0.250 inches may be used in larger seals. In this instance, for shafts of 6 inches or greater, the reluctance gap should be 0.055 to 0.075 inches and the product is dimensioned accordingly. Typically, the O ring groove 24, 50 is 0.14 inches to 0.18 inches wide and the O ring is thus from 0.090″ to 0.12″. This width of groove being substantially greater than the diameter of the O rings allows a certain amount of axial play in the use of the device.

It will thus be seen that the present invention provides a unitized oil seal made from synthetic material and having a number of advantages and characteristics including those herein pointed out and others which are inherent in the invention.

1. A magnetic bearing isolator assembly, said assembly comprising, in combination, first and second body parts, a ferromagnetic ring and a plurality of magnets received in spaced apart pockets, said first body part including seat means defined by axial and radial surfaces, and having seal means on at least one of said surfaces, a circumferential groove in said first body for receiving a ring of a ferromagnetic material, a first primary sealing end face surface and a radially outer groove in said body for accommodating said second body part, said groove being defined by first and second axial surfaces and a radial surface, said second, relatively rotatable body part including seal means thereon, a second primary sealing end face surface disposed directly opposite said first primary sealing end face surface, a plurality of pockets of a cylindrical configuration for receiving cylindrical magnets, said pockets being spaced equally apart within said second body part and said magnets being in directly opposed facing relation to said ferromagnetic ring, and an outer, frusto-conical surface on said second part, the outer diameter portion of said frusto-conical surface being very slightly larger than the diameter of said smaller axial surface whereby said first and second parts, when pressed together to form a unitized seal, are only destructively removable from each other, said first and second parts being made from a composite fluorocarbon-carbon-graphite material with substantial glass filling therein.

2. A magnetic bearing isolator assembly as defined in claim 1 wherein said ferromagnetic ring is an iron or steel ring.

3. A magnetic bearing isolator assembly as defined in claim 2 wherein said iron or steel ring is split, whereby said ring may temporarily assume a smaller diameter so as to fit axially within said circumferential groove.

4. A magnetic bearing isolator assembly as defined in claim 1 wherein said magnets are rare earth magnets.

5. A magnetic bearing isolator assembly as defined in claim 1 wherein said plural pockets are from six to ten pockets.

6. A magnetic bearing isolator assembly as defined in claim 1 wherein said seal means on at east one of said axial and radial surfaces on said first part includes a circumferential groove and an O-ring disposed in said groove.

7. A magnetic bearing isolator assembly as defined in claim 1 wherein said seal means on said second part includes a groove and an O-ring in said groove from forming a secondary seal with an associated shaft.

8. A magnetic bearing isolator assembly as defined in claim 1 wherein, in its assembled condition, said magnets are spaced from said ferromagnetic ring by a gap of from 0.040 to about 0.100 inches.

9. A magnetic bearing isolator assembly as defined in claim 8 wherein said spacing is from about 0.050 inches to about 0.075 inches.

10. A magnetic bearing isolator assembly as defined in claim 1 wherein said first and second parts are made from about 60% fluorocarbon, about 20/carbon-graphite and about 20% of a glass filler material.

11. A magnetic bearing isolator assembly as defined in claim 1 wherein said magnets are made from Neodymium 40, Iron and Boron.

12. A magnetic bearing isolator assembly as defined in claim 1 wherein said magnets are of cylindrical shape.

13. A magnetic bearing isolator assembly as defined in claim 1 wherein said magnets are cylindrical in shape with a diameter of about 0.189 and a length of about 0.200.

14. A magnetic bearing isolator assembly as defined in claim 1 wherein said magnets are cylindrical in shape with a diameter of about 0.250 and a length of about 0.250.

15. A magnetic bearing isolator assembly, said assembly comprising, in combination, first and second body parts, an iron-containing ring and a plurality of cylindrical magnets, said first body part including seat means defined by axial and radial surfaces, said axial surface including a circumferential groove for receiving an O-ring, to provide a secondary seal with an associated housing, a second circumferential groove in said first body part for receiving an iron-containing ring, a first end face primary sealing surface and a radially outer, relatively wide groove in said body, and a second, relatively rotatable second body part including a groove for receiving an O-ring to provide a secondary seal with an associated shaft, a second end face primary sealing surface disposed directly opposite said first end face surface, a plurality of pockets of a cylindrical configuration for receiving and retaining magnets, said pockets being spaced equally apart within said second body part and in directly opposed relation to said iron-containing ring, said second body part including an outer, frusto-conical surface, said frusto-conical surface and said radially outer, relatively wide groove being defined in party by an axial surface on said first part, said axial surface having a slightly smaller diameter than the smallest diameter of said frusto-conical surface, whereby said first and second parts, once assembled, are not removable non-destructively from each other, a plurality of cylindrical magnets being received in said pockets, said iron-containing ring being received within said second groove, said first and second bodies being molded from a composite, fluorocarbon-graphite material having a substantial amount of glass filling therein.
